(19) United States
(12) Patent Application Publication
(10) Pub. No.: US 2015/0241899 A1
(43) Pub. Date: Aug. 27, 2015

(54) CIRCUIT, TRANSCEIVER, AND COMMUNICATION SYSTEM

(71) Applicant: Sony Corporation, Tokyo (JP)

(72) Inventor: Yasuhiro Ochiai, Kanagawa (JP)

(21) Appl. No.: 14/615,025

(22) Filed: Feb. 5, 2015

(30) Foreign Application Priority Data
Feb. 26, 2014 (JP) 2014-035864

(51) Int. Cl. G05F 3/02

(52) U.S. Cl. CPC G05F 3/02

(57) ABSTRACT

A circuit includes a first driver, a second driver, a first capacitance, and a second capacitance. The first driver is configured to receive power supply from a first power source domain. The second driver is configured to receive power supply from a second power source domain that is different from the first power source domain. The first capacitance is connected to an output node of the first driver. The second capacitance is disposed between an output node of the second driver and the output node of the first driver.

### CROSS REFERENCE TO RELATED APPLICATIONS

This application claims the benefit of Japanese Priority Patent Application JP 2014-035864 filed Feb. 26, 2014, the entire contents of which are incorporated herein by reference.

### BACKGROUND

The present disclosure relates to a circuit, a transceiver, and a communication system.

Switching noise in the circuit operation of a large scale integrated circuit (LSI) is a factor that degrades the electrical properties of the LSI. The switching noise is generated due to charging/discharging current flowing through a signal node when a driver (I/O buffer amplifier, etc.) operates.

The driver operates when being supplied with power source voltage from a power source line and ground voltage from a ground line. An output capacitance is connected to a signal node connected to an output terminal of the driver, and the driver charges/discharges the output capacitance.

The charging current flowing through the signal node flows between the power source line and a signal line via a drive circuit, and the discharging current flowing through the signal node flows between the signal line and the ground line via the driver. The amount of charging/discharging current flowing through the signal node increases with increase in the capacitance of the signal node.

The voltage level of the power source or ground ideally has a constant value. However, if the amount of charging/discharging current flowing through the signal node is large, it may be impossible to keep the voltage level constant and variation is caused in the voltage level of the power source or ground over time.

If variation is caused in the voltage level of the power source or ground over time, dynamic fluctuations called jitter are caused in the operational delay time of the circuit in the LSI connected to the power source or ground. The jitter is a factor that degrades the electrical properties of the LSI. Examples of the electrical properties of the LSI degraded by the jitter include the state where the circuit properties are degraded due to the degradation of the set-up time or holding time of the circuit.

FIG. 12 are each a diagram for explaining the jitter caused in the operational delay time of the circuit in the LSI. FIG. 12A shows the schematic configuration of a double-data-rate (DDR) interface as an example of the circuit in the LSI, and FIG. 12B shows an eye waveform obtained by using the operation cycle to reflex the transient properties of a DQ00 signal shown in FIG. 12A.

If the power source voltage connected to each buffer amplifier shown in FIG. 12A is fluctuated, temporal fluctuations are caused in the transit time through the I/O circuit, and jitter is degraded in the eye waveform of the DQ00 signal as shown in FIG. 12B. As described above, if jitter is degraded, the electrical properties of the circuit in the LSI do not satisfy the specification.

As a countermeasure, there is a method of inserting as many bypass capacitors as possible between the power source of the LSI chip and the ground. In addition thereto, the techniques disclosed in Japanese Patent Application Laid-open No. 2003-124795, Japanese Patent Application Laid-open No. 2009-063302, and Japanese Patent Application Laid-open No. 2009-064921 have been known. These techniques detect fluctuations in the power source, use the detection signal as a correction signal for the fluctuations in the power source, and reduce the fluctuations in the power source through a correction circuit.

### SUMMARY

However, the realistic capacitance value of the bypass capacitor that can be inserted between the power source and the ground is several nF at most because the area of a mount surface for the LSI chip is limited. Therefore, even if the bypass capacitor is inserted between the power source and the ground, significant fluctuations are caused in the difference between the potential level of the power source and that of the ground (hereinafter, referred to as power source fluctuations), and the circuit properties are significantly degraded. Accordingly, it is not a sufficient countermeasure against jitter.

Moreover, the invention disclosed in any one of Japanese Patent Application Laid-open No. 2003-124795, Japanese Patent Application Laid-open No. 2009-063302, and Japanese Patent Application Laid-open No. 2009-064921 takes some time to correct the power source fluctuations. If the operational frequency of the power source fluctuations is high, it may be impossible to suppress the power source fluctuations during this time. Therefore, significant effects of improving the power source fluctuations with a high frequency are not obtained.

The present disclosure has been made in view of the above circumstances, and it is desirable to reduce the power source fluctuations caused due to the fluctuations in consumption current generated at the time of switching of the circuit.

According to an embodiment of the present disclosure, there is provided a circuit including a first driver configured to drive by receiving power supply from a first power source domain, a second driver configured to drive by receiving power supply from a second power source domain that is different from the first power source domain, a first capacitance connected to an output node of the first driver, and a second capacitance disposed between an output node of the second driver and the output node of the first driver.

According to an embodiment of the present disclosure, there is provided a transceiver including an input/output circuit including a first driver configured to drive by receiving power supply from a first power source domain, a second driver configured to drive by receiving power supply from a second power source domain that is different from the first power source domain, a first capacitance connected to an output node of the first driver, and a second capacitance disposed between an output node of the second driver and the output node of the first driver.

According to an embodiment of the present disclosure, there is provided a communication system including a first semiconductor integrated circuit including a first input/output circuit configured to transmit/receive a signal, and a second semiconductor integrated circuit including a second input/output circuit configured to transmit/receive a signal, at least one of the first input/output circuit and the second input/output circuit including a first driver configured to drive by receiving power supply from a first power source domain, a second driver configured to drive by receiving receive power supply from a second power source domain that is different from the first power source domain, a first capacitance connected to an output node of the first driver, and a second capacitance disposed between an output node of the second driver and the output node of the first driver.

The circuit, transceiver, or communication system described above includes various embodiments, e.g., they are implemented in the state of being incorporated into another apparatus or implemented with another method. Moreover, the embodiments of the present disclosure can be achieved as a system including the circuit, transceiver, or communication system, a method including the steps corresponding to the configuration of the circuit, transceiver, or communication system, a program that causes a computer to realize the function corresponding to the configuration of the circuit, transceiver, or communication system, a computer-readable recording medium that stores the program, and the like.

According to the present disclosure, it is possible to reduce the power source fluctuations caused due to the fluctuations in consumption current generated at the time of switching of the circuit. It should be noted that the effect described herein is not necessarily restrictive, and additional effects may be provided.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a circuit diagram showing the configuration of an I/O circuit according to a first embodiment of the present disclosure;

FIGS. 2A to 2C are each a diagram for explaining the power source fluctuations of a first power source;

FIG. 3 is a diagram showing the simulation of the correlation between the ratio of the driving capability of a driver and jitter;

FIG. 4 is a diagram showing the simulation of the correlation between the ratio of the driving capability of a driver and jitter;

FIG. 5 is a circuit diagram showing the configuration of an I/O circuit according to a second embodiment of the present disclosure;

FIG. 6 is a diagram showing an example of the circuit configuration of a timing adjustment circuit;

FIG. 7 is a diagram showing an example of an operation screen for commanding the timing adjustment of the I/O circuit;

FIG. 8 is a diagram for explaining the timing adjustment performed by a timing adjustment circuit;

FIG. 9 is a diagram showing the configuration of a control circuit in an LSI according to a third embodiment of the present disclosure;

FIG. 10 is a diagram showing the configuration of an I/O circuit according to a fourth embodiment of the present disclosure;

FIG. 11 is a diagram showing the configuration of a system according to a fifth embodiment of the present disclosure; and

FIGS. 12A and 12B are each a diagram for explaining jitter caused in the operational delay time of a circuit in an LSI.

### DETAILED DESCRIPTION OF EMBODIMENTS

Hereinafter, embodiments of the present disclosure will be described with reference to the drawings.

The description will be made in the following order.

(1) First embodiment
(2) Second embodiment
(3) Third embodiment
(4) Fourth embodiment
(5) Fifth embodiment

### (1) First embodiment

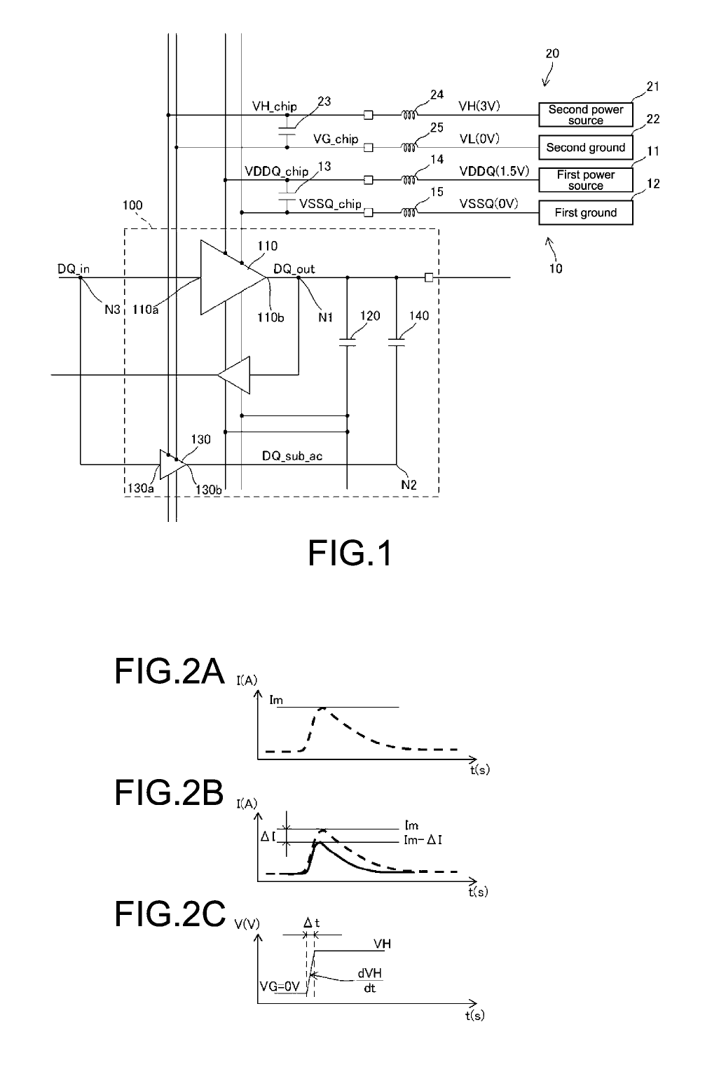

FIG. 1 is a circuit diagram showing the configuration of an I/O circuit according to a first embodiment of the present disclosure. An I/O circuit 100 shown in FIG. 1 includes a first driver 110, a load capacitance 120 that is connected to an output node N1 of the first driver 110 and serves as a first capacitance, a second driver 130 that has a lower driving capability (e.g., size) than the first driver 110, and an AC coupling capacitance 140 that connects an output node N2 of the second driver 130 and the output node N1 of the first driver 110 and serves as a second capacitance.

### (Frist Driver)

The first driver 110 is configured to receive power source voltage VDDQ (e.g., 1.5 V) from a first power source 11 and ground voltage VSSQ (e.g., 0 V) from a first ground 12, and to output, from an output terminal 110b, a signal DQ_out obtained by increasing the amount of current of an input signal DQ_in, which is input to an input terminal 110a from an input node N3, while shaping the waveform of the input signal DQ_in.

### (First Power Source Domain)

Between the first power source 11 and the first ground 12, a stabilizing capacitance 13 is provided to reduce power source noise or unnecessary electromagnetic emission (EMI) along therewith. An inductance 14 on the power source line connecting the first power source 11 and the first driver 110 is a wiring inductance of the power source line, and an inductance 15 on the ground line connecting the first ground 12 and the first driver 110 is a wiring inductance of the ground line. Hereinafter, the configuration according to the power supply from the first power source 11 and the first ground 12 to the first driver 110 is referred to as a first power source domain 10. In FIG. 1, the first power source 11, the first ground 12, the stabilizing capacitance 13, and the inductances 14 and 15 constitute the first power source domain 10.

### (Charging Operation Performed by First Driver)

It should be noted that when the input signal DQ_in transits from L to H, also the output of the first driver 110 is switched from L to H. At this time, a current path through which current flows from the first power source 11 to the load capacitance 120 via the first driver 110 is generated. Accordingly, the load capacitance 120 is charged.

The charging current to the load capacitance 120 voluntarily flows from the stabilizing capacitance 13. Therefore, an IR drop is generated in the first power source domain 10, and the level of voltage VDDQ_chip of a line through which the power source voltage VDDQ is transmitted in the I/O circuit 100 is fluctuated. This is the power source fluctuations caused due to the operation switching noise generated during charging of the load capacitance 120.

### (Discharging Operation Performed by First Driver)

On the other hand, when the input signal DQ_in transits from H to L, also the output of the first driver 110 is switched from H to L. At this time, a current path through which current flows from the load capacitance 120 to the first ground 12 via the first driver 110 is generated. Accordingly, the load capacitance 120 is discharged.

The discharging current from the load capacitance 120 mainly flows to the stabilizing capacitance 13. Therefore, the level of voltage VSSQ_chip of a line through which the ground voltage VSSQ is transmitted in the I/O circuit 100 is fluctuated. This is the power source fluctuations caused due to the operation switching noise generated during discharging of the load capacitance 120.

### (Second Driver)

The second driver 130 is configured to receive power source voltage VH (e.g., 3 V) from a second power source 21 and a ground potential VL (e.g., 0 V) from a second ground 22, and to output, to the output node N2, a signal DQ_sub_ac obtained by increasing the amount of current of the input signal DQ_in, which is input from the input node N3 to an input terminal 130a, while shaping the waveform of the input signal DQ_in.

### (Second Power Source Domain)

Between the second power source 21 and the second ground 22, a stabilizing capacitance 23 that reduces power source noise or EMI along therewith is provided. An inductance 24 on a wiring connecting the second power source 21 and the second driver 130 is a wiring inductance of a power source transmission line, and an inductance 25 on a wiring connecting the second ground 22 and the second driver 130 is a wiring inductance of a ground line.

Hereinafter, the configuration according to the power supply from the second power source 21 and the second ground 22 to each driver is referred to as a second power source domain 20. In FIG. 1, the second power source 21, the second ground 22, the stabilizing capacitance 23, and the inductances 24 and 25 constitute the second power source domain 20.

### (Charging Operation Performed by Second Driver)

It should be noted that the output node N2 of the second driver 130 is connected to the output node N1 of the first driver 110 via the AC coupling capacitance 140, and the output node of the second driver 130 is DC-electrically separated from the output node of the first driver 110. However, because the transition time of the output signal from the second driver 130 is short, the impedance of the capacitance of the AC coupling capacitance 140 is reduced during the transition of the output signal of the second driver 130, and the AC coupling capacitance 140 is short-circuited.

Therefore, during the transition of output of the second driver 130, current flows between the output node of the second driver 130 and the output node of the first driver 110, which are DC-electrically separated, via the AC coupling capacitance 140. In other words, it is possible to charge from the second power source 21 to the load capacitance 120, and to discharge from the load capacitance 120 to the second ground 22 via the AC coupling capacitance 140. It should be noted that the output signal of the first driver 110 has the same polarity as the output signal of the second driver 130, and the polarity of the output signal of the first driver 110 changes at almost the same timing as the polarity of the output signal of the second driver 130.

Specifically, when the input signal DQ_in transits from L to H, also the output of the second driver 130 is switched from L to H. At this time, a current path through witch current flows from the second power source 21 to the load capacitance 120 via the second driver 130 and the AC coupling capacitance 140 is generated. Accordingly, it is possible to assist the charging of the load capacitance 120 with the second driver 130.

Moreover, the input signal DQ_in transits from H to L, also the output of the second driver 130 is switched from H to L. At this time, a current path through which current flows from the load capacitance 120 to the second ground 22 via the AC coupling capacitance 140 and the second driver 130 is generated. Accordingly, it is possible to assist the discharging of the load capacitance 120 with the second driver 130.

FIG. 2 are each a diagram for explaining the power source fluctuations of the first power source 11. FIG. 2A shows the power source fluctuations of the first power source 11 in the case where an I/O circuit in which the second driver 130 and the AC coupling capacitance 140 are not provided is used. FIG. 2B shows the power source fluctuations of the first power source 11 in the case where the I/O circuit 100 is used. FIG. 2C shows the waveform of the input signal DQ_in.

As shown in FIG. 2A, only the first power source 11 functions as a charging source of the load capacitance 120 in the case where an I/O circuit in which the second driver 130 and the AC coupling capacitance 140 are not provided is used. Therefore, large current momentarily flows from the first power source 11 to the load capacitance 120 via the first driver 110. The peak current at this time is referred to as Im.

On the other hand, as shown in FIG. 2B, the first power source 11 and the second power source 21 function as charging sources of the load capacitance 120 in the case where the I/O circuit 100 is used. Therefore, the amount of current that flows from the first power source 11 to the load capacitance 120 via the first driver 110 is reduced to (Im−ΔI). It should be noted that ΔI is represented by the following formula (1):

$$Δ I = C\_dq \_ac \times \frac{d VH}{d t} . \qquad ( 1 )$$

In the formula (1), VH (e.g., 3 V) represents output voltage of the second driver 130 in the case where H is continuously input as the input signal DQ_in, and dt represents a time necessary for the output voltage to transit from VG (e.g., 0 V) to VH when the input signal DQ_in transits from L to H. In the formula (1), VG represents output voltage of the second driver 130 when L is continuously input as the input signal DQ_in, and (dVH/dt) represents the slope of the output voltage of the second driver 130 changing from VG to VH when the input signal DQ_in transits from L to H. The (dVH/dt) varies by changing the output resistance value of the second driver 130.

Therefore, based on the formula (1), it can be seen that the peak value of charging current from the first power source 11 to the load capacitance 120 is determined by the output resistance value of the second driver 130 and a capacitance value (C_dq_sub) of the AC coupling capacitance 140.

Moreover, in order to validate the assist of charging/discharging performed by the second driver 130, it is favorable to increase the current ΔI that flows from the second driver 130 to the load capacitance 120. If the voltage (VH) of the second power source 21 is increased, the capacitance value of the AC coupling capacitance 140 is increased, or the output resistance value of the second driver 130 is increased, the current AI can be increased. However, an increase in the capacitance value of the AC coupling capacitance 140 or the output resistance value of the second driver 130 results in an increase in the area of the mount surface for the I/O circuit 100. Therefore, a method of making the voltage of the second power source 21 larger than the voltage of the first power source 11 is suitable.

### (Effects: Conclusion)

As described above, the I/O circuit 100 according to this embodiment is configured to supply charging current from the second power source domain 20 in which the power source fluctuations can be caused to the load capacitance 120 while supplying charging current from the first power source domain 10, which is desired to reduce the power source fluctuations, to the load capacitance 120, to assist the charging of the load capacitance 120. Therefore, the charging current from the first power source domain 10, which is desired to reduce the power source fluctuations, to the load capacitance 120 is reduced, and it is possible to reduce the power source fluctuations caused in the first power source domain 10 by the charging of the load capacitance 120.

Moreover, the I/O circuit 100 according to this embodiment is configured to discharge from the load capacitance 120 to the second power source domain 20 in which the power source fluctuations can be caused while discharging from the load capacitance 120 to the first power source domain 10, which is desired to reduce the power source fluctuations, to assist the discharging of the load capacitance 120. Therefore, the discharging current from the load capacitance 120 to the first power source domain 10, which is desired to reduce the power source fluctuations, is reduced, and it is possible to reduce the power source fluctuations caused in the first power source domain 10 by the discharging of the load capacitance 120.

### (Ratio of Driving Capability)

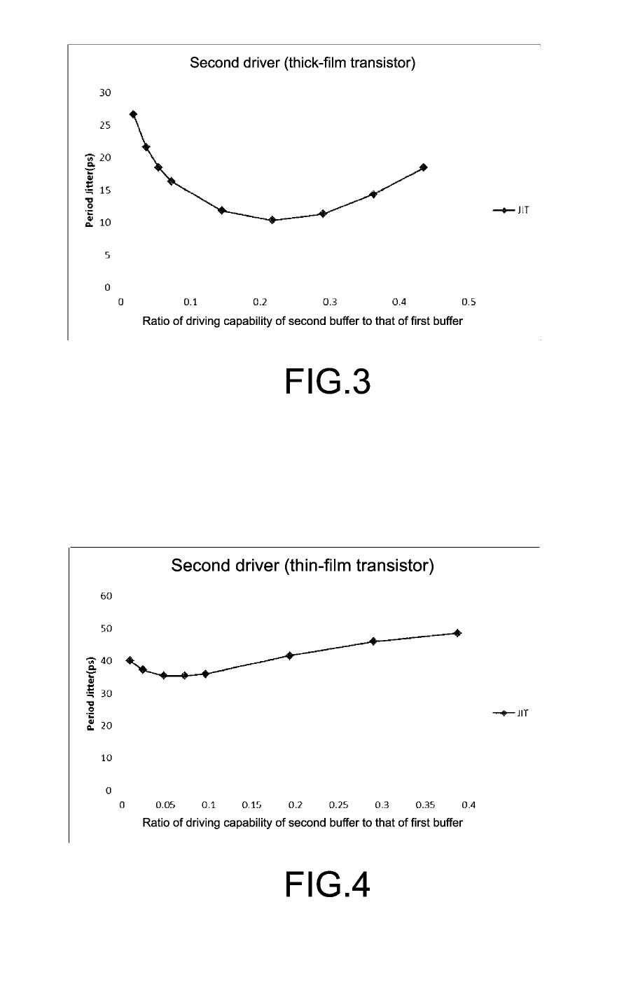

It should be noted that the ratio of driving capability of the first driver 110 or the second driver 130 is not particularly limited, and can be used in combination. It should be noted that it is possible to optimize the ratios of the drive capabilities of the first driver 110 and the second driver 130 based on the following correlation in FIG. 3 or FIG. 4 to maximize the effects of reducing the power source fluctuations.

FIG. 3 and FIG. 4 are diagrams showing the simulation of the correlation between the ratios of the driving capabilities of the first driver 110 and the second driver 130 and jitter caused in the I/O circuit 100, respectively. FIG. 3 shows a case where the second driver 130 is formed of a thick-film transistor, and FIG. 4 shows a case where the second driver 130 is formed of a thin-film transistor.

In the case where the second driver 130 is formed of a thick-film transistor, if the ratio of driving capability S2 (not shown) of the second driver 130 to a driving capability S1 (not shown) of the first driver 110 (S2/S1) is about 0.2, the jitter is minimized as shown in FIG. 3. In the case where the second driver 130 is formed of a thin-film transistor, if the ratio S2/S1 is about 0.05, the jitter minimized as shown in FIG. 4.

### (2) Second Embodiment

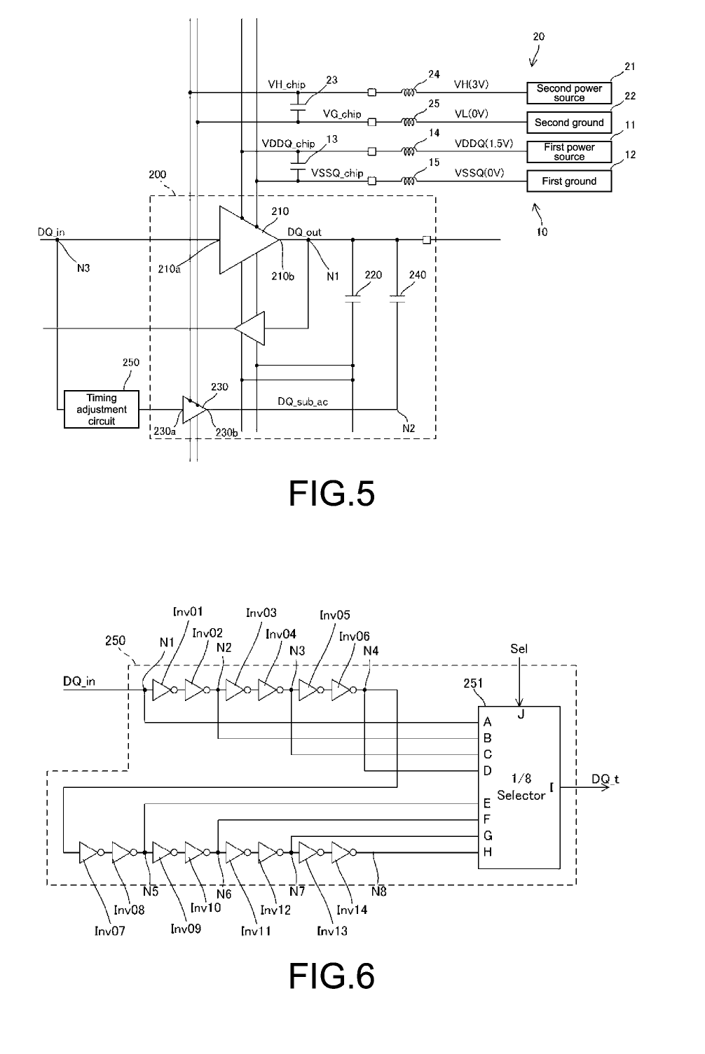

FIG. 5 is a circuit diagram showing the configuration of an I/O circuit according to a second embodiment of the present disclosure. An I/O circuit 200 shown in FIG. 5 is different from the I/O circuit 100 according to the first embodiment in that the input signal DQ_in is input to a second driver 230 via a timing adjustment circuit 250.

It should be noted that a first driver 210, a load capacitance 220, the second driver 230, and an AC coupling capacitance 240 included in the I/O circuit 200 have the same configurations as those of the first driver 110, the load capacitance 120, the second driver 130, and the AC coupling capacitance 140 included in the I/O circuit 100, respectively. In the following, the detailed description thereof will be omitted.

The timing adjustment circuit 250 is configured to adjust the timing for inputting the input signal DQ_in to the second driver 230 so that the signal transition of the signal DQ_out of the first driver 210 is performed simultaneously with the signal transition of the signal DQ_sub_ac of the second driver 230. In FIG. 5, the input signal DQ_in is input to the timing adjustment circuit 250, and the timing adjustment circuit 250 generates a signal DQ_t obtained by delaying the input signal DQ_in for a predetermined time and inputs the generated signal DQ_t to the second driver 230.

It should be noted that in this embodiment, the timing adjustment circuit 250 is used to delay the input signal to the second driver 230 because an example in which the delay time of the first driver 210 is longer than that of the second driver 230 is described. However, in the case where the delay time of the first driver 210 is shorter than that of the second driver 230, the timing adjustment circuit 250 may be used to delay the input signal to the first driver 210. Moreover, in the case where there is no need to adjust the output timing of the first driver 210 and the second driver 230 (output timing of the first driver 210 matches with that of the second driver 230), it does not have to provide a timing adjustment circuit.

FIG. 6 is a diagram showing an example of the circuit configuration of a timing adjustment circuit. The timing adjustment circuit 250 shown in FIG. 6 includes a plurality of inverters Inv01 to Inv14 connected in series and a selector circuit 251 configured to output an input from an output terminal I to any one of a plurality of input terminals A to H. To the plurality of input terminals A to H, voltage at different connection points of the plurality of inverters Inv01 to Inv14 is input.

In FIG. 6, the plurality of inverters Inv01 to Inv14 connected in series each have a delay time Δt. Therefore, a signal transmitted through the plurality of inverters Inv01 to Inv14 is delayed by the delay time Δt every time the signal transmits through one inverter.

For example, if adjacent two inverters are referred to a set of inverters, the delay time of a signal at the connection point of each set of inverters (which is referred to as connection points N1 to N8 in the order of nearer point to the input side) is 0 at the connection point N1, 2Δt at the connection point N2, 4Δt at the connection point N3, 6Δt at the connection point N4, 8Δt at the connection point N5, 10Δt at the connection point N6, 12Δ at the connection point N7, and 14Δt at the connection point N8. In FIG. 6, the connection points N1 to N8 are connected to the different input terminals A to H.

The selector circuit 251 is configured to output, from the output terminal I, a signal input to any one of the input terminals A to H in response to a delay selection signal Sel input to a control terminal J. The output signal output from the output terminal I is the terminal DQ_t. It should be noted that the delay selection signal Sel may be set to select an input from a predetermined input terminal and output the selected input in advance in the design stage, or may be adjusted in accordance with an actual delay time T1 of the first driver 210 before shipment or after shipment, specifically, to satisfy the relationship of T1=T2+T3. It should be noted that T3 represents a delay time of the second driver 230, and T2 represents a delay time of the timing adjustment circuit 250.

### (Software-Based Timing Adjustment)

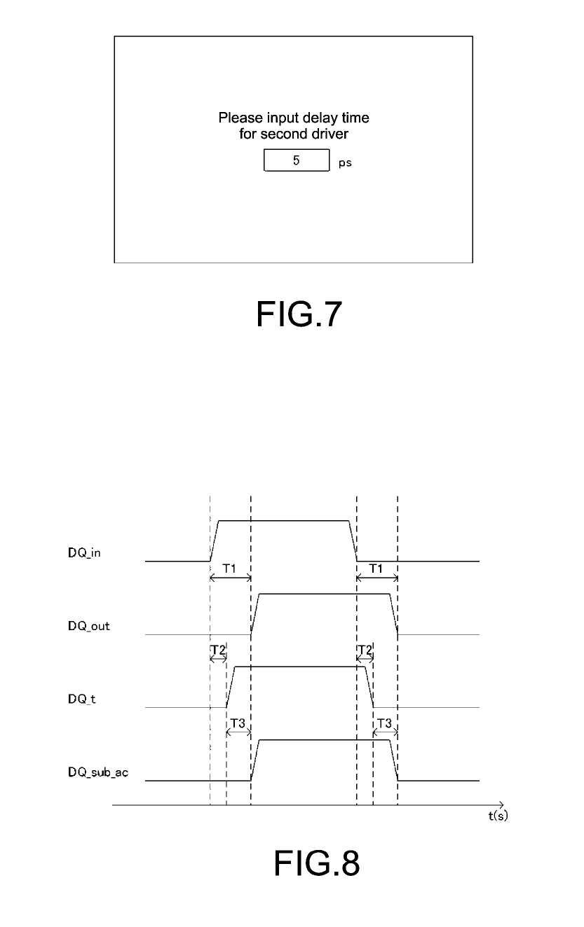

FIG. 7 is a diagram showing an example of an operation screen for commanding the timing adjustment of the I/O circuit 200. This operation screen is displayed on an interface screen of an electronic device (e.g., transmitter, receiver, and transceiver) including the I/O circuit 200 or an electronic device communicably connected to such an electronic device including the I/O circuit 200.

In the example shown in FIG. 7, it is possible to select the value of the delay time T2 and input the selected value. The user can change the delay time T2 variously by using an operation input means to perform an operation input on the interface screen. It should be noted that on the interface screen for adjusting the delay time T2, the results of timing adjustment performed with the designated delay time T2 may be displayed in addition thereto. Examples of such display include an eye waveform obtained by sampling the signal DQ_out of the I/O circuit 200 and using the operation cycle to reflex the transient properties of the signal DQ_out.

FIG. 8 is a diagram for explaining the timing adjustment. In the example shown in FIG. 8, the signal DQ_out of the first driver 210 is delayed by the delay time T2 with respect to the signal DQ_sub_ac of the second driver 230 out is output.

At this time, if the delay time of the first driver 210 (time lag from the input of the input signal DQ_in to the output of the signal DQ_out in the case where no timing adjustment circuit 250 is provided) is T1 and the delay time of the second driver 230 (Time lag from the input of the input signal DQ_in to the output of the signal DQ_sub_ac in the case where no timing adjustment circuit 250 is provided) is T3, the delay time T2 of the timing adjustment circuit 250 is determined so as to satisfy the relationship of T1=T2+T3.

Accordingly, the signal transition of the output signal DQ_out of the first driver 210 is performed simultaneously with the signal transition of the signal DQ_sub_ac of the second driver 230, and it is possible to improve the effects of reducing the switching noise in the power source voltage VDDQ of the first power source 11 or the ground voltage VSSQ of the first ground 12, and to effectively reduce the power source fluctuations in the first power source domain.

### (3) Third embodiment

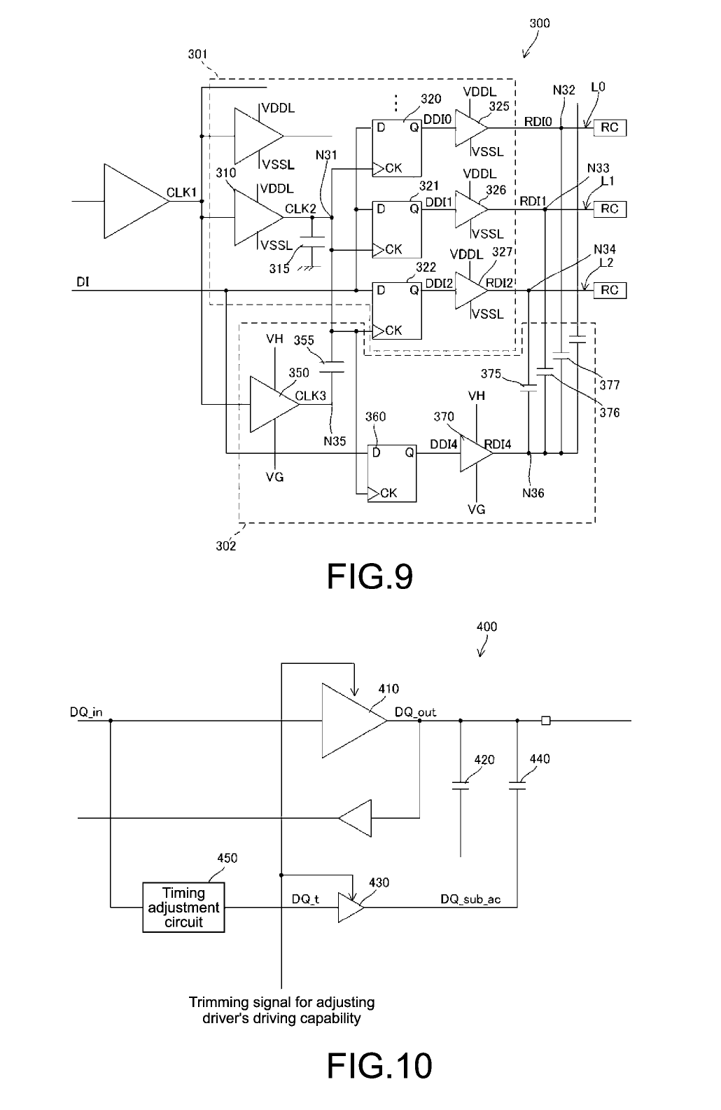

FIG. 9 is a diagram showing the configuration of a control circuit in an LSI according to a third embodiment of the present disclosure.

A control circuit 300 shown in FIG. 9 includes a first circuit block 301 configured to drive by receiving power supply from the first power source domain and a second circuit block 302 configured to drive by receiving power supply from the second power source domain. In the example shown in FIG. 9, VDDL (1.1 V) and VSSL (0 V) are supplied from the first power source domain, and VH (3 V) and VL (0 V) are supplied from the second power source domain.

The first circuit block 301 includes a driver 310, a load capacitance 315 of the driver 310, flip-flops 320 to 322 whose CK terminals are connected to an output node N31 of the driver 310, a driver 325 whose input terminal is connected to a Q terminal of the flip-flop 320, a driver 326 whose input terminal is connected to a Q terminal of the flip-flop 321, and a driver 327 whose input terminal is connected to a Q terminal of the flip-flop 322.

A clock signal CLK1 is input to the input terminal of the driver 310, and a clock signal CLK2 is output from the driver 310 to the output node N31. The clock signal CLK2 is a signal obtained by increasing the amount of current of the clock signal CLK1 while shaping the waveform of the clock signal CLK1 and by delaying the clock signal CLK1 by the delay time T1.

The flip-flops 320 to 322 are D-type flip-flops. A data signal DI is input to the respective D terminals of the flip-flops 320 to 322, and the clock signal CLK2 of the output node N31 is input to the respective CK terminals of the flip-flops 320 to 322.

The flip-flops 320 to 322 are configured to delay an input to the D terminal and output the delayed input from the Q terminal. The flip-flops 320 to 322 output an input that has reached the D terminal before a clock pulse enters in, from the Q terminal on the trailing edge of the clock pulse. Hereinafter, a signal output from the Q terminal of the flip-flop 320 is a delay data signal DDI0, a signal output from the Q terminal of the flip-flop 321 is a delay data signal DDI1, and a signal output from the Q terminal of the flip-flop 322 is a delay data signal DDI2.

The delay data signal DDI0 from the flip-flop 320 is input to the input terminal of the driver 325, and the driver 325 outputs, to an output node N32, a reproduction delay data signal RDI0 obtained by increasing the amount of current the delay data signal DDI0 while shaping the waveform of the delay data signal DDI0.

The delay data signal DDI1 from the flip-flop 321 is input to the input terminal of the driver 326, and the driver 326 outputs, to an output node N33, a reproduction delay data signal RDI1 obtained by increasing the amount of current of the delay data signal DDI1 while shaping the waveform of the delay data signal DDI1.

The delay data signal DDI2 from the flip-flop 322 is input to the input terminal of the driver 327, and the driver 327 outputs, to an output node N34, a reproduction delay data signal RDI2 obtained by increasing the amount of current of the delay data signal DDI2 while shaping the waveform of the delay data signal DDI2.

A wiring L0 is connected to the output node N32, a wiring L1 is connected to the output node N33, and a wiring L2 is connected to the output node N34. Each of the wirings L0 to L2 has a wiring load RC.

### (Schematic Configuration of Second Circuit Block)

The second circuit block 302 includes a driver 350, an AC coupling capacitance 355 provided between an output node N35 of the driver 350 and the output node N31 of the driver 310, a flip-flop 360 whose CK terminal is connected to the output node N31, a driver 370 whose input terminal is connected to a Q terminal of the flip-flop 360, and AC coupling capacitances 375 to 377 that connect an output node N36 of the driver 370 and the output nodes N32 to N34 of the drivers 325 to 327, respectively. The driver 350 and the driver 370 are configured to drive by receiving power supply from the second power source domain.

### (Driver 350)

The driver 350 is configured to receive the input of the clock signal CLK1 and output a clock signal CLK3 to the output node N35. The clock signal CLK3 is obtained by increasing the amount of current of the clock signal CLK1 while shaping the waveform of the clock signal CLK1, and is delayed by the delay time T3 with respect to the clock signal CLK1. The clock signal CLK3 is supplied to the output node N31 via the AC coupling capacitance 355.

Specifically, to the output node N31, the clock signal CLK2 output from the driver 310 and the clock signal CLK3 output from the driver 350 are supplied. Therefore, the load capacitance 315 is charged by the charging current supplied from the first power source domain via the driver 310 and the charging current supplied from the second power source domain via the driver 350, and is discharged by the discharging current to the first power source domain via the driver 310 and the discharging current to the second power source domain via the driver 350.

As described above, by using the driver 350 to assist charging/discharging to the load capacitance 315, it is possible to reduce the charging current from the first power source domain to the load capacitance 315 or the discharging current from the load capacitance 315 to the first power source domain even in the case where the load capacitance for driving the driver 310 is high. As a result, it is possible to reduce the power source fluctuations in the first power source domain caused by charging/discharging of the load capacitance 315.

### (Relationship Between Delay Times of Drivers 310 and 350)

The delay time T1 of the driver 310 and the delay time T3 of the driver 350 are adjusted so that the output timing of the clock signal CLK2 with respect to the clock signal CLK1 matches with that of the clock signal CLK3.

It should be noted that in the case where there is a time lag between the delay time T1 and the delay time T3, it is possible to adjust the timing so that the relationship of T1=T2+T3 is satisfied by providing the same circuit having the delay time T2 as the timing adjustment circuit according to the second embodiment at the previous stage of the driver 350 or the driver 310.

### (Description of Flip-Flop)

The flip-flop 360 is a D-type flip-flop. The data signal DI is input to the D terminal, and the clock signal CLK2 is input to the CK terminal of the flip-flop 360 from the driver 310.

The flip-flop 360 is configured to delay an input to the D terminal and output the delayed input from the Q terminal. The flip-flop 360 outputs an input that has reached the D terminal before a clock pulse enters in, from the Q terminal on the trailing edge of the clock pulse. Hereinafter, a signal output from the Q terminal of the flip-flop 360 is referred to as delay data signal DDI4.

The delay data signal DDI4 is input from the flip-flop 360 to the input terminal of the driver 370, and the driver 370 outputs, to an output node N36, a reproduction delay data signal RDI4 obtained by increasing the amount of current of the delay data signal DDI4 while shaping the waveform of the delay data signal DDI4.

The reproduction delay data signal RDI4 output from the driver 370 is supplied to the output nodes N32 to N34 of the drivers 325 to 327 via the AC coupling capacitance 375 to 377, respectively.

Accordingly, the wiring capacitance of the wiring L0 connected to the output node N32 is charged by the charging current supplied from the first power source domain via the driver 325 and the charging current supplied from the second power source domain via the driver 370, and is discharged by the discharging current to the first power source domain via the driver 325 and the discharging current to the second power source domain via the driver 370.

Similarly, the wiring capacitance of the wiring L1 connected to the output node N33 is charged by the charging current supplied from the first power source domain via the driver 326 and the charging current supplied from the second power source domain via the driver 370, and is discharged by the discharging current to the first power source domain via the driver 326 and the discharging current to the second power source domain via the driver 370.

Similarly, the wiring capacitance of the wiring L2 connected to the output node N34 is charged by the charging current supplied from the first power source domain via the driver 327 and the charging current supplied from the second power source domain via the driver 370, and is discharged by the first discharging current to the power source domain via the driver 327 and the discharging current to the second power source domain via the driver 370.

As described above, in the case where a plurality of signal lines (in this embodiment, the wirings L0 to L2) in which the signal transition is simultaneously performed at the same polarity can be predicted in advance, by connecting the signal line and another driver (in this embodiment, the driver 370) that receives power supply from the second power source domain that is different from the first power source domain via the AC coupling capacitance (in this embodiment, the AC coupling capacitances 375 to 377) to assist the charging/discharging, it is possible to collectively reduce the power source fluctuations caused due to the simultaneous switching noise in the first power source domain.

### (4) Fourth Embodiment

FIG. 10 is a diagram showing the configuration of an I/O circuit according to a fourth embodiment of the present disclosure. An I/O circuit 400 shown in FIG. 10 has the same configuration as the I/O circuit 200 according to the second embodiment except that the driver's driving capability can be adjusted by a trimming signal for adjusting a driver's driving capability.

It should be noted that a first driver 410, a load capacitance 420, a second driver 430, an AC coupling capacitance 440, and a timing adjustment circuit 450 of the I/O circuit 400 have the same configurations of those of the first driver 210, the load capacitance 220, the second driver 230, the AC coupling capacitance 240, and the timing adjustment circuit 250 of the I/O circuit 200, respectively. In the following, the detailed description thereof will be omitted.

In this embodiment, the I/O circuit 400 is configured so that the driving capabilities of the first driver 410 and the second driver 430 can be calibrated by a control signal input from the outside of the I/O circuit 400. In this case, in order to adjust the driving capability of the first driver 410, also the driving capability of the second driver 430 is adjusted simultaneously. Similarly, in order to adjust the driving capability of the second driver 430, also the driving capability of the first driver 410 is adjusted simultaneously. At this time, the adjustment is performed so that the ratio between the capabilities of the first driver 410 and the second driver 430 are maintained. Accordingly, it is possible to reduce the fluctuations in the circuit properties before and after the adjustment.

### (5) Fifth Embodiment

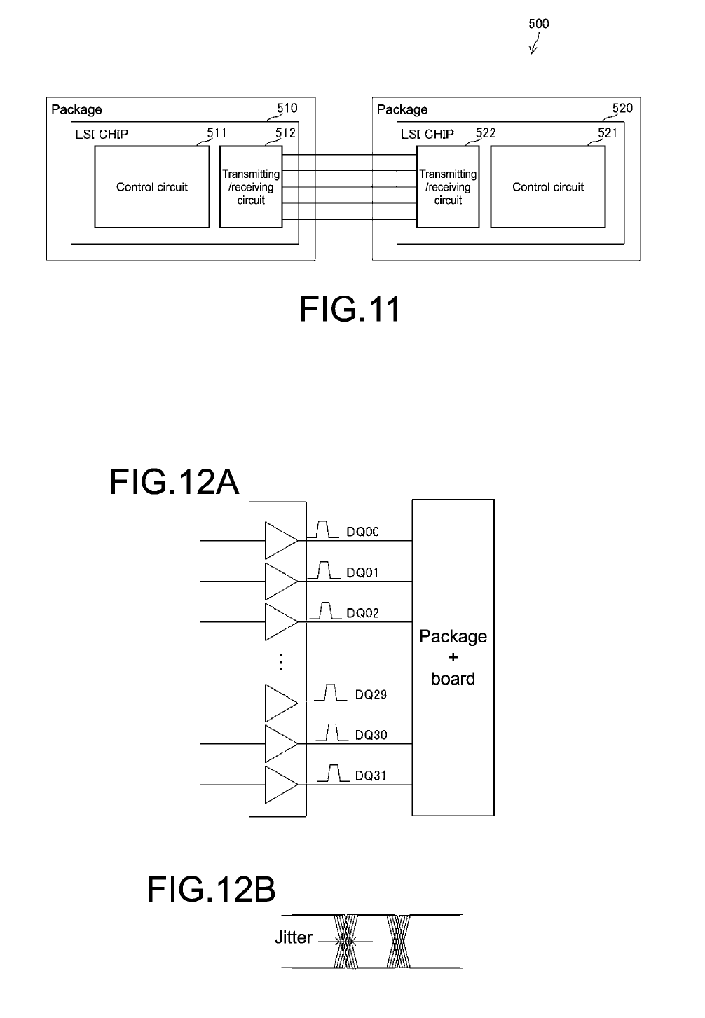

FIG. 11 is a diagram showing the configuration of a system according to a fifth embodiment of the present disclosure.

A communication system 500 shown in FIG. 11 includes an LSI chip 510 and an LSI chip 520. The LSI chip 510 includes a control circuit 511 and a transmitting/receiving circuit 512, and the LSI chip 520 includes a control circuit 521 and a transmitting/receiving circuit 522. It should be noted that the LSI chip 510 and the LSI chip 520 may be mounted on the same board, or may be mounted on different boards. Examples of the LSI chip 510 and the LSI chip 520 include LSI chips connected by a high speed interface, such as a memory and a central processing unit (CPU), and a CPU and a graphics processing unit (GPU).

The transmitting/receiving circuits 512 and 522 may have the configuration of the I/O circuit described in the first embodiment, the second embodiment, or the fourth embodiment. As a matter of course, only one of the transmitting/receiving circuits 512 and 522 may have the above-mentioned configuration of the I/O circuit. Moreover, the control circuits 511 and 521 may have the configuration of the control circuit described in the third embodiment. As a matter of course, only one of the transmitting/receiving circuits 512 and 522 may have the above-mentioned configuration.

It should be noted that embodiments of the present disclosure are not limited to the above-mentioned embodiments, and include a configuration obtained by replacing the configurations disclosed in the above-mentioned embodiments with each other or changing the combination thereof, a combination obtained by replacing the configurations disclosed in well-known techniques and the above-mentioned embodiments with each other or changing the combination thereof, and the like. Moreover, the technical range of the embodiments of the present disclosure is not limited to the above-mentioned embodiments, and includes matters described in claims and equivalents thereof.

The present disclosure may also take the following configurations.

(A) A circuit, including:

a first driver configured to drive by receiving power supply from a first power source domain;

a second driver configured to drive by receiving power supply from a second power source domain that is different from the first power source domain;

a first capacitance connected to an output node of the first driver; and

a second capacitance disposed between an output node of the second driver and the output node of the first driver.

(B) The circuit according to (A) above, in which

an output signal of the first driver has the same polarity as an output signal of the second driver.

(C) The circuit according to (A) or (B) above, in which

polarity of an output signal of the first driver changes at almost the same timing as polarity of an output signal of the second driver.

(D) The circuit according to (A) or (B) above, in which

an input signal input to the first driver is input also to the second driver via a timing adjustment circuit, and

the timing adjustment circuit is configured to delay an input of the input signal to the second driver for a predetermined time.

(E) The circuit according to any one of (A) to (D) above, in which

the second driver is configured by using a thick-film transistor, and

the second driver has a driving capability that is about 0.2 times as large as that of the first driver.

(F) The circuit according to any one of (A) to (E) above, in which

the second driver is configured by using a thin-film transistor, and

the second driver has a driving capability that is about 0.05 times as large as that of the first driver.

(G) The circuit according to any one of (A) to (F) above, in which

the first driver includes a plurality of first drivers,

the first capacitance is connected to respective output nodes of the plurality of first drivers,

states of signals change between an active-high state and an active-low state simultaneously at outputs of the plurality of first drivers, and

the output node of the second driver is connected to respective output nodes of the plurality of first drivers via a second capacitance.

(H) A transceiver, including

an input/output circuit including
a first driver configured to drive by receiving power supply from a first power source domain,
a second driver configured to drive by receiving power supply from a second power source domain that is different from the first power source domain,
a first capacitance connected to an output node of the first driver, and
a second capacitance disposed between an output node of the second driver and the output node of the first driver.
   (I) The transceiver according to (H) above, in which

an input signal input to the first driver is input also to the second driver via a timing adjustment circuit, and

the timing adjustment circuit is configured to delay an input of the input signal to the second driver for a predetermined time, the transceiver further including
a controller configured to control the delay time of the timing adjustment circuit.
   (J) The transceiver according to (H) or (I) above, further including

a driving capability-adjusting means configured to adjust a driving capability of the first driver and a driving capability of the second driver so that a ratio between the driving capability of the first driver and the driving capability of the second driver is maintained.

(K) A communication system, including:

a first semiconductor integrated circuit including a first input/output circuit configured to transmit/receive a signal; and

a second semiconductor integrated circuit including a second input/output circuit configured to transmit/receive a signal, at least one of the first input/output circuit and the second input/output circuit including
a first driver configured to drive by receiving power supply from a first power source domain,

a second driver configured to drive by receiving power supply from a second power source domain that is different from the first power source domain,

a first capacitance connected to an output node of the first driver, and

a second capacitance disposed between an output node of the second driver and the output node of the first driver.

It should be understood by those skilled in the art that various modifications, combinations, sub-combinations and alterations may occur depending on design requirements and other factors insofar as they are within the scope of the appended claims or the equivalents thereof.

What is claimed is:

1. A circuit, comprising:
a first driver configured to receive power supply from a first power source domain;
a second driver configured to receive power supply from a second power source domain that is different from the first power source domain;
a first capacitance connected to an output node of the first driver; and
a second capacitance disposed between an output node of the second driver and the output node of the first driver.

2. The circuit according to claim 1, wherein
an output signal of the first driver has the same polarity as an output signal of the second driver.

3. The circuit according to claim 1, wherein
polarity of an output signal of the first driver changes at almost the same timing as polarity of an output signal of the second driver.

4. The circuit according to claim 1, wherein
an input signal input to the first driver is input also to the second driver via a timing adjustment circuit, and
the timing adjustment circuit is configured to delay an input of the input signal to the second driver for a predetermined time.

5. The circuit according to claim 1, wherein
the second driver is configured by using a thick-film transistor, and
the second driver has a driving capability that is about 0.2 times as large as that of the first driver.

6. The circuit according to claim 1, wherein
the second driver is configured by using a thin-film transistor, and
the second driver has a driving capability that is about 0.05 times as large as that of the first driver.

7. The circuit according to claim 1, wherein
the first driver includes a plurality of first drivers,
the first capacitance is connected to respective output nodes of the plurality of first drivers,
states of signals change between an active-high state and an active-low state simultaneously at outputs of the plurality of first drivers, and
the output node of the second driver is connected to respective output nodes of the plurality of first drivers via a second capacitance.

8. A transceiver, comprising
an input/output circuit including
a first driver configured to receive power supply from a first power source domain,
a second driver configured to receive power supply from a second power source domain that is different from the first power source domain,
a first capacitance connected to an output node of the first driver, and
a second capacitance disposed between an output node of the second driver and the output node of the first driver.

9. The transceiver according to claim 8, wherein
an input signal input to the first driver is input also to the second driver via a timing adjustment circuit, and
the timing adjustment circuit is configured to delay an input of the input signal to the second driver for a predetermined time, the transceiver further including
a controller configured to control the delay time of the timing adjustment circuit.

10. The transceiver according to claim 8, further comprising
a driving capability-adjusting means configured to adjust a driving capability of the first driver and a driving capability of the second driver so that a ratio between the driving capability of the first driver and the driving capability of the second driver is maintained.

11. A communication system, comprising:
a first semiconductor integrated circuit including a first input/output circuit configured to transmit/receive a signal; and
a second semiconductor integrated circuit including a second input/output circuit configured to transmit/receive a signal, at least one of the first input/output circuit and the second input/output circuit including
a first driver configured to receive power supply from a first power source domain,
a second driver configured to receive power supply from a second power source domain that is different from the first power source domain,
a first capacitance connected to an output node of the first driver, and
a second capacitance disposed between an output node of the second driver and the output node of the first driver.
